(19) United States
(12) Patent Application Publication
(10) Pub. No.: US 2016/0229753 A1
(43) Pub. Date: Aug. 11, 2016

(54) METHOD OF FABRICATING A CERAMIC ARTICLE

(71) Applicant: UNITED TECHNOLOGIES CORPORATION, Hartford, CT (US)

(72) Inventors: Wayde R. Schmidt, Pomfret Center, CT (US); Paul Sheedy, Bolton, CT (US); Tania Bhatia Kashyap, West Hartford, CT (US)

(21) Appl. No.: 15/022,680

(22) PCT Filed: Sep. 5, 2014
(86) PCT No.: PCT/US2014/054254

§ 371 Date: Mar. 17, 2016

Related U.S. Application Data
(60) Provisional application No. 61/879,765, filed on Sep. 19, 2013.

(51) Int. Cl. C04B 35/628

(52) U.S. Cl. CPC C04B 35/62844; C04B 2235/614; C04B 2235/616

(57) ABSTRACT

A method of fabricating a ceramic article includes serially depositing first, second and third different materials within a porous structure using, respectively, first, second and third different processing techniques, to form a ceramic-containing article. The first, second and third materials differ by at least one of composition and microstructure. The first, second and third different processing techniques differ by at least one of modes of delivery of precursor materials into the porous structure and formation mechanisms of the first, second and third different materials from the precursor materials. The deposition of the first material is controlled such that there are first residual voids in the porous structure in which the second material is deposited. The deposition of a second material is controlled such that there are second residual voids in the porous structure in which the third material is deposited.

### CROSS-REFERENCE TO RELATED APPLICATION

This application claims priority to U.S. Provisional Application No. 61/879,765, filed Sep. 19, 2013.

### BACKGROUND

This disclosure pertains to ceramic composites. Ceramic composites are fabricated using a technique such as polymer infiltration and pyrolysis, melt infiltration, slurry infiltration, slip casting, tape casting, injection molding, dry pressing, isostatic pressing, hot isostatic pressing and others. The selected processing technique controls the chemistry and microstructure of the ceramic composite and thus can also limit the chemistry and microstructure.

### SUMMARY

A method of fabricating a ceramic article according to an example of the present disclosure includes serially depositing first, second and third different materials within a porous structure using, respectively, first, second and third different processing techniques, to form a ceramic-containing article. The first, second and third different materials differ by at least one of: composition and microstructure, and the first, second and third different processing techniques differ by at least one of: modes of delivery of precursor materials into the porous structure and formation mechanisms of the first, second and third different materials from the precursor materials. The depositing of the first material is controlled such that there are first residual voids in the porous structure into which the second material is deposited and the depositing of the second material is controlled such that there are second residual voids in the porous structure into which the third material is deposited.

A further embodiment of any of the foregoing embodiments includes selecting respective compositions of at least two materials of the first, second and third different materials to be reactive with each other during the deposition.

A further embodiment of any of the foregoing embodiments includes selecting respective compositions of at least two of the first, second and third different materials to be chemically inert with each other during the deposition.

In a further embodiment of any of the foregoing embodiments, the first residual voids are interconnected pores that are unfilled by the first material and the second residual voids are micro-cracks within the second material.

In a further embodiment of any of the foregoing embodiments, the first residual voids and the second residual voids are interconnected pores, the interconnected pores of the second residual voids being within the second material.

In a further embodiment of any of the foregoing embodiments, the porous structure is a fiber structure.

In a further embodiment of any of the foregoing embodiments, the deposition of the first material provides a continuous coating on the porous structure.

In a further embodiment of any of the foregoing embodiments, the first, second and third different processing techniques are selected from the group consisting of chemical vapor infiltration of a gas, polymer infiltration and pyrolysis of a polymer, melt infiltration of a metallic material and vapor infiltration of a metallic material.

In a further embodiment of any of the foregoing embodiments, the third processing technique includes one of the melt infiltration of the metallic material or the vapor infiltration of the metallic material.

In a further embodiment of any of the foregoing embodiments, the second processing technique includes the deposition of a preceramic polymer including a filler that chemically reacts with at least one of the first material and the third material.

In a further embodiment of any of the foregoing embodiments, at least one of the first, second and third different processing techniques includes chemically reacting a precursor material deposited thereby with a residual amount of unreacted precursor material from another of the first, second and third different processing techniques.

In a further embodiment of any of the foregoing embodiments, at least two of the first, second and third materials include ceramic materials.

A method of fabricating a ceramic article according to an example of the present disclosure includes serially depositing first, second and third different materials within a porous structure using, respectively, first, second and third different processing techniques selected from the group consisting of chemical vapor infiltration of a gas, polymer infiltration and pyrolysis of a polymer, melt infiltration of a metallic material and vapor infiltration of a metallic material, to form a ceramic-containing article. The first, second and third different materials differ by at least one of composition and microstructure. The depositing of the first material is controlled such that there are first residual voids in the porous structure into which the second material is deposited and the depositing of the second material is controlled such that there are second residual voids in the porous structure into which the third material is deposited.

In a further embodiment of any of the foregoing embodiments, the first, second and third different processing techniques are, respectively, the chemical vapor infiltration of the gas, the polymer infiltration and pyrolysis of the polymer and one of the melt infiltration of the metallic material or the vapor infiltration of the metallic material.

In a further embodiment of any of the foregoing embodiments, the third processing technique is one of the melt infiltration of the metallic material or the vapor infiltration of the metallic material.

In a further embodiment of any of the foregoing embodiments, the ceramic-containing article is substantially fully dense and substantially free of voids.

In a further embodiment of any of the foregoing embodiments, the third processing technique is melt infiltration of a metallic material or vapor infiltration of a metallic material. The first processing technique is the polymer infiltration and pyrolysis of a polymer and the second processing technique is the chemical vapor infiltration of a gas to deposit a continuous protective layer of the second material around the first material to limit reaction between the later deposited metallic material deposited by the melt infiltration or vapor infiltration.

In a further embodiment of any of the foregoing embodiments, the porous structure is an unstable fiber structure and the first processing technique provides a continuous layer of the first material that rigidizes the fiber structure such that the fibers maintain a desired fiber arrangement upon the second and third processing techniques.

A ceramic article fabricated by a method according to an example of the present disclosure includes serially depositing first, second and third different materials within a porous structure using, respectively, first, second and third different processing techniques, to form a ceramic-containing article. The first, second and third different materials differ by at least one of composition and microstructure. The first, second and third different processing techniques differ by at least one of modes of delivery of precursor materials into the porous structure and formation mechanisms of the first, second and third different materials from the precursor materials. The depositing of the first material is controlled such that there are first residual voids in the porous structure into which the second material is deposited and the depositing of the second material is controlled such that there are second residual voids in the porous structure into which the third material is deposited.

In a further embodiment of any of the foregoing embodiments, the ceramic-containing article includes the porous structure with the first material disposed in voids of the porous structure, the second material disposed at least in the first residual voids of the porous structure and the third material disposed in at least the second residual voids in the porous structure

### DETAILED DESCRIPTION

Disclosed herein is a method of fabricating a ceramic article. As will be appreciated, the method provides a synergistic effect of at least three different processing techniques to form a ceramic article that can have enhanced densification, thermal conductivity or other target property for a desired end use, such as in a turbine engine. For example, the ceramic article fabricated according to this disclosure can be a fiber-reinforced ceramic matrix composite, but is not limited to such a structure.

As used herein, a ceramic material is an inorganic, non-metallic compound having metallic and non-metallic elements that have mixed ionic and covalent bonding, depending on the particular ceramic. In further examples, the ceramic material can have a crystalline, partly crystalline, amorphous (glassy) or partly amorphous microstructure. In further examples, the ceramic article can be entirely or predominantly, by weight, ceramic material. If not entirely ceramic, the ceramic article can also include metallic or intermetallic phases and/or free carbon phases. In one example, the ceramic article fabricated according to this disclosure is a fiber-reinforced ceramic matrix composite. The ceramic matrix can be entirely ceramic material or can include continuous or discontinuous metallic and/or intermetallic phases and/or free carbon phases. The carbon phases can include glassy carbon, graphitic carbon, graphene, fullerenes or diamond. In one further example, the ceramic matrix includes at least one continuous phase in which the fiber reinforcement is dispersed.

An example of the method includes serially depositing first, second and third different materials within a porous structure using, respectively, first, second and third different processing techniques. In one example, the porous structure is a fiber structure. The fiber structure can be a woven structure, but is not limited to such an arrangement. The fibers can be ceramic fibers, carbon fibers, glass fibers, metal fibers or combinations thereof, but are not limited to such fibers. In gas turbine engines and other applications subject to severe operating conditions, silicon carbide, silicon carbide nitride and/or carbon fibers are useful.

The fibers can include core fibers and, optionally, one or more interface layers on the outside of the fibers that serve as interfacial layers with a deposited matrix. Such interface layers are known and can be used to provide desired weak interfacial bonding between the fibers and matrix, environmental protection of the fibers and/or other functions related to a particular end use. Example interface layers can be single or multilayer arrangements of layers of any of carbon, boron nitride, silicon carbide, and silicon nitride, but are not limited to such materials.

The first, second and third materials differ by at least one of composition and microstructure. Composition refers to a representative chemical formulation of atoms of the material, and compositions that include common elements are considered different if the numbers of atoms of that element differ in the chemical formulation. Similarly, materials that include common elements with the same number of atoms of a common element in the chemical formulations are considered different if the microstructural arrangement of the common element atoms with respect to other element atoms in the chemical formulation differ. Microstructure refers to observable or detectable features of a phase or region of a material. For example, microstructures can differ by crystalline arrangements of atoms.

The first, second and third different processing techniques differ by at least one of modes of delivery of precursor materials into the porous structure and formation mechanisms of the first, second and third different materials from the precursor materials. The term “processing technique” thus refers to the kind of technique, rather than to variations between specific, but similar processes. In this regard, different processing techniques can differ in the way that precursor material or materials are delivered into the porous structure. Thus, different modes of delivery can include, but are not limited to, delivery by liquid melt or by vaporized gas, for example.

The processing techniques can further or alternatively differ by the formation mechanisms of the materials, and preferably of ceramic materials, from the precursor material(s) used in the particular technique. Thus, different formation mechanisms can include, but are not limited to, formation by thermal pyrolysis in which a precursor decomposes to a final material (e.g., a ceramic) or intermediate material, by mere non-reactive solidification from a liquid melt, by gas phase reaction between precursor gases and condensation of the reaction product, and by mere gas phase condensation of a non-reacted gaseous precursor, for example.

Additionally, in some examples, although some characteristics may differ between two specific processes, such characteristics do not necessarily differentiate the two processes when the modes of delivery of the precursor material(s) are the same or the formation mechanisms are the same. For instance, one melt infiltration technique is not different from another merely because the temperatures of the infiltrations differ, nor are two polymer infiltration techniques different merely because different compositions of polymer precursors are used. However, polymer infiltration/pyrolysis is a different processing technique than simple melt or vapor infiltration, even though each includes infiltration, because the infiltrations ultimately utilize different formation mechanisms to obtain a final material (pyrolysis versus mere solidification). Given this description, one of ordinary skill in the art will be able to distinguish different processing techniques that may be of interest.

The depositing of the first material in the porous structure is controlled such that there are first residual voids in the porous structure, in which the second material is later deposited. The depositing of the second material is also controlled such that there are second residual voids in the porous structure in which the third material is later deposited. Thus, whereas the objective in using an individual processing technique alone would be to avoid the formation of residual voids, the processing techniques used herein are, contrary to normal objectives when using an individual processing technique alone, adapted to produce residual voids in order to accommodate later-deposited materials. Void formation can be controlled by including pore-formers, controlling shrinkage, reactions that create a removable phase or inclusions of phases that can be removed by way of dissolution, volatilization, melting and related methods.

In further examples, the first, second and third different processing techniques are selected from different ones of chemical vapor infiltration of a ceramic precursor gas or other gas, polymer infiltration of a preceramic polymer or other polymer, melt infiltration of a metallic material and vapor infiltration of a metallic material. Furthermore, the materials selected to be deposited using the different processing techniques, along with the particular order in which the techniques are used to serially deposit the different materials, can be selected to enhance a target property or properties of the ceramic article, such as but not limited to enhancement of densification and enhancement of thermal conductivity.

In one example, the first processing technique is chemical vapor infiltration of a ceramic precursor gas to deposit a ceramic material, the second processing technique is polymer infiltration/pyrolysis of a preceramic polymer to deposit a ceramic material and the third processing technique is one of melt infiltration of a metallic material or vapor infiltration of a metallic material. The techniques are conducted serially such that the materials are deposited serially in the porous structure. For instance, the chemical vapor infiltration of a ceramic precursor gas or other gas is used to first deposit a relatively thin layer. The thin layer can be a ceramic, such as silicon carbide, silicon nitride, boron nitride, boron carbide, or graphite or other carbon phases, but are not limited to such materials. The process is, contrary to normal objectives, stopped such that the porous structure is incompletely filled with the deposited ceramic material. Thus, there are first residual voids in the porous structure for receiving the second material. Additionally, using chemical vapor deposition can allow for a [PS1]matrix portion adjacent fibers of a fiber structure, providing good protection for the fibers and interface coating, along with a high thermal conductivity pathway. However, chemical vapor deposition can be deficient in forming fully dense matrices, especially for relatively large and complex geometry parts, often “canning off” regions of the material and preventing further infiltration. The resulting closed pores can be angular and can limit the strength of the material. Therefore, the chemical vapor infiltration process can be stopped, prematurely before reaching the point of “canning off” and a second process is then be used to further densify the bulk of the matrix.

In one example, the first residual voids include an interconnected porosity that permits at least the second material to infiltrate throughout the porous structure. Additionally, the deposition of the first material in the first processing technique can also serve to rigidize the porous structure and, depending upon the selected material that is deposited, provide a continuous thermally conductive layer within the porous structure. For instance, the rigidization is one non-limiting example of the synergy of using multiple processing techniques. The rigidization can be used to stabilize an otherwise unstable fiber structure so that the fibers do not move, or do not substantially move, from the desired arrangement upon being handled in or subjected to the subsequent processing techniques.

The second processing technique is polymer infiltration/pyrolysis, in which a preceramic polymer is deposited at least into the first residual voids in the porous structure. The preceramic polymer can be selected such that it converts to a desired ceramic material phase or phases upon pyrolysis. In some examples, the preceramic polymer converts to silicon carbide, silicon nitride, silicon oxycarbide or combinations thereof. In this regard, the pyrolysis temperature and environment can be controlled according to the selected preceramic polymer to obtain the desired ceramic material phase or phases and/or desired microstructure. In a further example, the preceramic polymer can be a blend of two or more different preceramic polymers to provide two or more different ceramic material phase compositions or microstructures.

The composition of the second material deposited by the polymer infiltration/pyrolysis process and/or process parameters can also be selected to produce certain types of the second residual voids, such as a preferred configuration of micro-cracks, for receiving the later-deposited third material. A typical matrix deposited by polymer infiltration/pyrolysis is selected to increase in density by volatilization of pyrolysis by-products, resulting in a controlled shrinkage of nominally 40-70 vol %, and resulting in formation of distributed pores and microcracks. In such cases, the thermal profile may be adjusted, such as with a faster heating rate, to alter these pyrolysis reactions, thereby resulting in changes in the morphology and or amount of porosity and microcracking. In one example, heating rates of 5° C./minute or greater can cause more rapid volatilization of the pyrolysis by-products and result in the formation of pores and micro-cracks with larger dimensions. In other examples, the preferred porosity and/or microcracking configuration can be created via the use of polymers which contain up to 20 vol % of a filler that can be removed subsequently by dissolution in a solvent or by volatilization by exposure to heat or vacuum. The microcracks and porosity created can provide infiltration passages for the infiltration of the later-deposited third material. Additionally, the polymer infiltration/pyrolysis process can be terminated prematurely to allow sufficient porosity and microcracking for the third material to later be deposited. In one example, the polymer infiltration/pyrolysis process is conducted such that only the very periphery of the article is capable of being infiltrated with a third material, such as silicon (melt), in order to limit the amount of residual metal phase in the composite, and simultaneously seal the surface of the article for improved long term durability (e.g. oxidation resistance). In other examples, the final stages of polymer infiltration/pyrolysis process can be conducted to allow only for limited infiltration of the later, third material at the periphery, which seals the surface and simultaneously reacts with the infiltrating metal to result in little to no residual metal remaining. In other examples, the later, third material infiltrates throughout the entire article, again sealing the porosity, and may or may not react partially or completely.

In further examples, one or more preceramic polymers can be filled with a reactive or inert filler. In the case of a reactive filler, the composition of the reactive filler can be selected to chemically react with the selected composition of the first material from the first processing technique and/or the composition of the third material of the later, third processing technique. This provides the ability to form additional ceramic phases in the ceramic article to further alter the properties of the article as desired and is another non-limiting example of the synergy of using multiple processing techniques. In the case of an inert filler, the composition of the inert filler is can be selected in accordance with the compositions of either or both of the first and third materials so that the inert filler does not react or substantially react with the first and/or third materials. In this way, the composition and microstructure of the inert filler is preserved in the final ceramic article and is another non-limiting example of the synergy of using multiple processing techniques to avoid reactions that could otherwise debit the final ceramic article.

The third processing technique in this example is one of melt infiltration of a metallic material or vapor infiltration of a metallic material. For example, liquid or vaporized free silicon metal (which can also be referred to as a metalloid) is infiltrated into the second residual voids. The free silicon metal can fully or partially react with either or both of the first and second materials, or constituents thereof, to provide a desired ceramic phase. For example, free silicon metal deposited to react with carbon from the first and/or second material to form silicon carbide. In a further example, the preceramic polymer used in the polymer infiltration/pyrolysis process of the second technique can be composed to provide a stoichiometric excess of carbon upon pyrolysis conversion for in-situ reaction with the free silicon metal or other metallic material deposited in the third processing technique. The in-situ reaction is another non-limiting example of the synergy of using multiple processing techniques.

The melt infiltration or vapor infiltration of the metallic material is used in this example as the last processing technique. Using the melt or vapor infiltration as the last of the processing techniques avoids temperature or other processing limitations that may otherwise limit later processing techniques if melt or vapor infiltration were not last. Furthermore, the melt or vapor infiltration can be used as the last processing technique to fully densify the ceramic article such that it is free or substantially free of any voids. For comparison, a combination of only two processing techniques, such as chemical vapor infiltration and polymer infiltration/pyrolysis, may be unable to close all residual porosity. However, the last technique of melt or vapor infiltration can be used to fill any remaining voids to achieve a fully or substantially fully dense article and is another non-limiting example of the synergy of using multiple processing techniques.

As can be appreciated, different serial orders of the above-example processing techniques can alternatively be used to achieve different advantages. In another example, the serial order of the processing techniques can be polymer infiltration/pyrolysis, chemical vapor infiltration, followed by melt or vapor infiltration to fill any remaining voids. In this example, the chemical vapor infiltration can be used to deposit a continuous, relatively thin protective layer around the material deposited by the polymer infiltration/processing technique. Thus, the protective layer can be used to avoid or limit reaction between the later deposited metallic material of the melt or vapor infiltration and the material deposited by the earlier polymer infiltration/pyrolysis process, whereas these materials would normally react with each other if in direct contact. As can be appreciated, the disclosed techniques can alternatively be conducted in other serial orders to achieve other synergistic benefits.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A method of fabricating a ceramic article, the method comprising:
serially depositing first, second and third different materials within a porous structure using, respectively, first, second and third different processing techniques, to form a ceramic-containing article, the first, second and third different materials differing by at least one of:
composition and
microstructure, and
the first, second and third different processing techniques differing by at least one of:
modes of delivery of precursor materials into the porous structure and
formation mechanisms of the first, second and third different materials from the precursor materials,
the depositing of the first material being controlled such that there are first residual voids in the porous structure into which the second material is deposited and the depositing of the second material being controlled such that there are second residual voids in the porous structure into which the third material is deposited.

2. The method as recited in claim 1, further comprising selecting respective compositions of at least two materials of the first, second and third different materials to be reactive with each other during the deposition.

3. The method as recited in claim 1, further comprising selecting respective compositions of at least two of the first, second and third different materials to be chemically inert with each other during the deposition.

4. The method as recited in claim 1, wherein the first residual voids are interconnected pores that are unfilled by the first material and the second residual voids are micro-cracks within the second material.

5. The method as recited in claim 1, wherein the first residual voids and the second residual voids are interconnected pores, the interconnected pores of the second residual voids being within the second material.

6. The method as recited in claim 1, wherein the porous structure is a fiber structure.

7. The method as recited in claim 1, wherein the deposition of the first material provides a continuous coating on the porous structure.

8. The method as recited in claim 1, wherein the first, second and third different processing techniques are selected from the group consisting of chemical vapor infiltration of a gas, polymer infiltration and pyrolysis of a polymer, melt infiltration of a metallic material and vapor infiltration of a metallic material.

9. The method as recited in claim 8, wherein the third processing technique includes one of the melt infiltration of the metallic material or the vapor infiltration of the metallic material.

10. The method as recited in claim 1, wherein the second processing technique includes the deposition of a preceramic polymer including a filler that chemically reacts with at least one of the first material and the third material.

11. The method as recited in claim 1, wherein at least one of the first, second and third different processing techniques includes chemically reacting a precursor material deposited thereby with a residual amount of unreacted precursor material from another of the first, second and third different processing techniques.

12. The method as recited in claim 1, wherein at least two of the first, second and third materials include ceramic materials.

13. A method of fabricating a ceramic article, the method comprising:
serially depositing first, second and third different materials within a porous structure using, respectively, first, second and third different processing techniques selected from the group consisting of chemical vapor infiltration of a gas, polymer infiltration and pyrolysis of a polymer, melt infiltration of a metallic material and vapor infiltration of a metallic material, to form a ceramic-containing article, the first, second and third different materials differing by at least one of:
composition and
microstructure,
the depositing of the first material being controlled such that there are first residual voids in the porous structure into which the second material is deposited and the depositing of the second material being controlled such that there are second residual voids in the porous structure into which the third material is deposited.

14. The method as recited in claim 13, wherein the first, second and third different processing techniques are, respectively, the chemical vapor infiltration of the gas, the polymer infiltration and pyrolysis of the polymer and one of the melt infiltration of the metallic material or the vapor infiltration of the metallic material.

15. The method as recited in claim 13, wherein the third processing technique is one of the melt infiltration of the metallic material or the vapor infiltration of the metallic material.

16. The method as recited in claim 13, wherein the ceramic-containing article is substantially fully dense and substantially free of voids.

17. The method as recited in claim 13, wherein the third processing technique is melt infiltration of a metallic material or vapor infiltration of a metallic material, the first processing technique is the polymer infiltration and pyrolysis of a polymer and the second processing technique is the chemical vapor infiltration of a gas to deposit a continuous protective layer of the second material around the first material to limit reaction between the later deposited metallic material deposited by the melt infiltration or vapor infiltration.

18. The method as recited in claim 13, wherein the porous structure is an unstable fiber structure and the first processing technique provides a continuous layer of the first material that rigidizes the fiber structure such that the fibers maintain a desired fiber arrangement upon the second and third processing techniques.

19. A ceramic article fabricated by a method comprising:
serially depositing first, second and third different materials within a porous structure using, respectively, first, second and third different processing techniques, to form a ceramic-containing article, the first, second and third different materials differing by at least one of:
composition and
microstructure, and
the first, second and third different processing techniques differing by at least one of:
modes of delivery of precursor materials into the porous structure and
formation mechanisms of the first, second and third different materials from the precursor materials,
the depositing of the first material being controlled such that there are first residual voids in the porous structure into which the second material is deposited and the depositing of the second material being controlled such that there are second residual voids in the porous structure into which the third material is deposited.

20. The article as recited in claim 19, wherein the ceramic-containing article includes the porous structure with the first material disposed in voids of the porous structure, the second material disposed at least in the first residual voids of the porous structure and the third material disposed in at least the second residual voids in the porous structure
